(19) United States
(12) Patent Application Publication
(10) Pub. No.: US 2020/0103999 A1
(43) Pub. Date: Apr. 2, 2020

(54) ELECTRONIC DEVICE

(71) Applicant: SHARP KABUSHIKI KAISHA, Osaka (JP)

(72) Inventors: REIKA NAKANO, Osaka (JP); YASUAKI FUKUYAMA, Osaka (JP); SHUJI DAIOKU, Osaka (JP)

(21) Appl. No.: 16/586,897

(22) Filed: Sep. 27, 2019

(30) Foreign Application Priority Data
Oct. 2, 2018 (JP) 2018-187622

(51) Int. Cl. G06F 3/041; G06K 9/00; H04M 1/02

(52) U.S. Cl. CPC G06F 3/0412; H04M 2250/22; H04M 1/0266; G06K 9/0002

(57) ABSTRACT

A smartphone includes: a touch panel display unit that has a recessed first notched portion formed in part of an outer side of the touch panel display unit; and a fingerprint sensor that is at least, partly located inside the first notched portion.

### BACKGROUND

### 1. Field

The present disclosure relates to an electronic device including a touch panel display unit and a touch sensor.

### 2. Description of the Related Art

In recent years, some electronic devices such as smartphones and tablets include a screen lock mechanism for personal information protection.

Some electronic devices include, in order to achieve such a mechanism, a fingerprint sensor that enables personal authentication. Such a device is configured such that when a user touches the fingerprint sensor, the electronic device returns from a standby mode (power saving mode) to a normal operation mode so that the device does not unnecessarily consume electric power. In addition, in order to protect personal information, access to the entire or part of operation of the device is not allowed unless personal authentication by the fingerprint sensor reading a fingerprint succeeds.

For example, an electronic apparatus (smartphone) disclosed in Japanese Unexamined Patent Application Publication (Translation of PCT Application) No. 2017-522642 (publicly disclosed on Aug. 10, 2017) includes, in a frame region in the lower portion of a display unit, a fingerprint sensor functioning as a touch sensor. With this configuration, when a user touches or swipes the fingerprint sensor, personal authentication is performed through reading of a fingerprint and a screen is unlocked so that the user can browse a display screen.

Incidentally, with regard to electronic devices such as smartphones and tablets in recent years, an effort has been made to make a frame region as small as possible, to thereby make a display region larger. Further, technically, with bent wiring including a flexible circuit board, a small frame region that is apparently almost ignorable has been achieved.

The above-mentioned related art, however, has a problem in that the fingerprint sensor is mounted in the frame region outside the rectangular display unit, and hence the frame region has at least a given width, resulting in a difficulty in achieving a larger screen.

Accordingly, in a case where emphasis is placed on providing the largest possible display unit (display) on a casing, a fingerprint sensor is provided on a rear surface opposite to a display unit of an electronic device. With such a configuration, however, a user performs operation for, for example, unlocking a screen on the surface opposite to the display unit, resulting in inconvenient operation.

One aspect of the present disclosure has been made in view of the related-art problems described above, and is aimed at providing an electronic device that includes a touch sensor mounted on the same plane as a display unit and may make its frame region as small as possible.

### SUMMARY

In order to deal with the above-mentioned problems, according to an aspect of the present disclosure, there is provided an electronic device including: a touch panel display unit that has a recessed first notched portion formed in part of an outer side of the touch panel display unit; and a touch sensor that is at least partly located inside the first notched portion.

### Advantageous Effects of Invention

An aspect of the disclosure advantageously provides an electronic device that includes a touch sensor mounted on the same plane as a display unit and may make frame region as small as possible.

### BRIEF DESCRIPTION OF THE DRAWINGS

FIG. 1 is a plan view illustrating the configuration of an electronic device according to Embodiment 1 of the present disclosure;

FIG. 2A is a perspective view illustrating the configuration of a fingerprint sensor f the electronic device;

FIG. 2B is a schematic sectional view illustrating the fingerprint sensor being touched with a finger;

FIG. 2C is a schematic sectional view illustrating the principal configuration of the fingerprint sensor;

FIG. 3A is a principal-part plan view illustrating operation of unlocking through touching on the fingerprint sensor of the electronic device;

FIG. 3E 3B is a principal-part plan view illustrating operation of swiping right or left with the finger from the fingerprint sensor to an extended display region, to thereby perform basic screen operation;

FIG. 3C is a principal-part plan view illustrating operation of swiping with the finger from one of the extended display regions to the other of the extended display regions through the fingerprint sensor, to thereby perform horizontal scroll operation on a screen;

FIG. 4A is a plan view illustrating the configuration of an electronic device according to Embodiment 2 of the present disclosure, the electronic device having a first notched portion with a rectangular recessed portion;

FIG. 4B is a plan view illustrating the electronic device having a first notched portion with a semicircular recessed portion;

FIG. 5 is a plan view illustrating the configuration an electronic device according to Embodiment 8 of the present disclosure; and

FIG. 6 is a plan view illustrating the configuration an electronic device according to Embodiment 4 of the present disclosure.

### DESCRIPTION OF THE EMBODIMENTS

### Embodiment 1

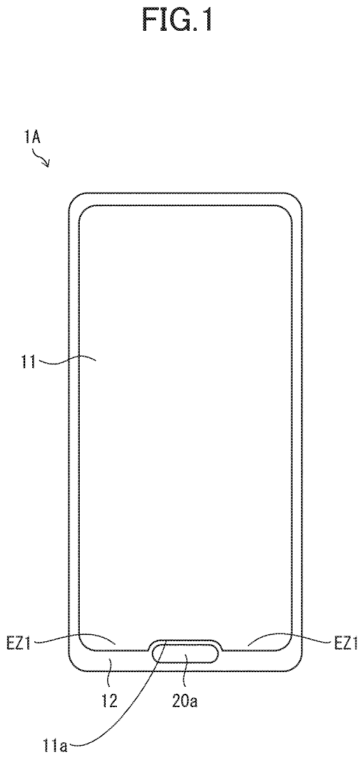

One embodiment of the present disclosure is described in detail with reference to FIG. 1 to FIG. 3C.

An electronic device according to one aspect of the present disclosure is, for example, a smartphone.

FIG. 1 is a plan view illustrating the configuration of a smartphone 1A that is the electronic device of the present embodiment.

The smartphone includes, as illustrated in FIG. 1, a touch panel display unit 11 and a frame region 12.

The touch panel display unit 11 is, for example, a display screen portion of a display including, for example, a liquid crystal display element or an organic electro luminescence (EL) display element. Moreover, the touch panel display unit 11 also has an interface function of detecting a finger or the like in contact with the surface thereof, thereby enabling input of a given instruction to the smartphone 1A by a user. Such a touch panel function can be achieved through provision of a contact detection element that is a liquid crystal display element or an organic EL display element, for example. The present disclosure is, however, not limited to such a configuration, and may use a well-known touch panel technology appropriately. The user can perform desired input operation by touching or swiping a specific touch panel display region. Note that, “touching” means bringing the finger or the like into contact with a screen, and “swiping” means sliding the finger or the like in contact with the screen.

In the present application, the outline shape the periphery of the touch panel display unit is a polygonal shape. In the present application, the “outer side of the touch panel display unit” means the side of the polygon the touch panel display unit having the polygonal periphery. Here, “the outline shape is a polygonal shape” means that a shape is regarded as a polygonal shape as a whole. Such a shape may include, for example, a rounded polygonal shape having curved corners. As a result, the “touch panel display unit having a recessed first notched portion formed in part of the outer side thereof” means that the outline shape of the periphery of the touch panel display unit is a polygonal shape, and the recessed first notched portion is formed in part of the side of the polygon.

Moreover, in the present application, the “recessed first notched portion formed in part of the outer side” means a series of notched portion provided in part of the side of the above-mentioned polygon so that the periphery thereof projects into the polygon and part of the polygon is thereby lost.

In the present embodiment, as illustrated in FIG. 1, the touch panel display unit 11 specifically has a rounded rectangular shape. That is, as a specific example of the polygonal shape, a rectangular shape, which is a quadrilateral shape, is applied. Further, the rectangular shape has rounded corners.

In addition, the present embodiment, a firs, notched portion 11a is formed at the middle of the lower side of the touch panel display unit 11. Here, the “lower side” represents a vertical relationship with respect to an image that is principally displayed on the touch panel display unit 11. Similarly, an “upper side”, a “right side”, and a “left side” used herein each represent a relationship wit: respect to an image that is principally displayed on the touch panel display unit 11. In the present embodiment, the first notched portion 11a (defective portion) specifically has a shape that is (horizontally long) rectangular and rounded corners and longitudinal sides extended along the lower side of the touch panel display unit 11. In other words, the shape of the first notched portion 11a (defective portion) is the shape of the upper half of a (horizontally long) oval shape (track shape) having longitudinal sides extended along the lower side.

The reason why the first notched portion 11a has the shape of the upper half of the horizontally long oval shape (track shape) is that the first notched portion 11a is formed so as to be matched with the shape of a fingerprint sensor 20a that is a horizontally long oval shape (track shape), for example.

The fingerprint sensor 20a functioning as a touch sensor is provided so as to be at least partly located inside the first notched portion 11a. Here, “being at least partly located inside the first notched portion 11a” means being at least partly located on the inner side of a line segment extended along the outer side on which the first notched portion 11a is provided. The fingerprint sensor 20a may be completely or partly accommodated inside the notched portion 11a. As an example of the present embodiment, as illustrated in FIG. 1, the fingerprint sensor 20a having the horizontally long oval shape is placed so that the upper half thereof is accommodated inside the first notched portion 11a.

The frame region 12 is a non-display region provided around the touch panel display unit 11, and is also called “bezel”. That is, the frame region 12 corresponds to a region other than the touch panel display unit 11 of the surface of the smartphone 1A (electronic device) on which the touch panel display unit 11 is formed. On the frame region 12, terminals, circuits, and wiring for inputting signals to the touch panel display unit 11 may be arranged.

In the smartphone 1A, the frame region 12 has an area that is made as small as possible and desirably has the smallest possible area. Thus, as illustrated in FIG. 1, the outline of the smartphone 1A is a rounded rectangular shape slightly larger than the touch panel display unit 11 having the rounded rectangular shape. The width of the frame region 12 on the lower-side side of the touch panel display unit 11 is larger than the widths of the frame region 12 on the remaining three sides to a certain degree because the fingerprint sensor 20a is placed so that the lower half thereof protrudes from the lower side of the touch panel display unit 11.

The fingerprint sensor 20a functions as the touch sensor configured to detect whether the finger or the like is brought into contact with the fingerprint sensor 20a or not. The electronic device can be constituted to return from a standby mode (power saving mode) to a normal operation mode when the user touches the fingerprint sensor 20a so that the smartphone 1A does not unnecessarily consume electric power. In addition, the fingerprint sensor 20a enables personal authentication with a fingerprint for locking or unlocking the screen of the smartphone 1A.

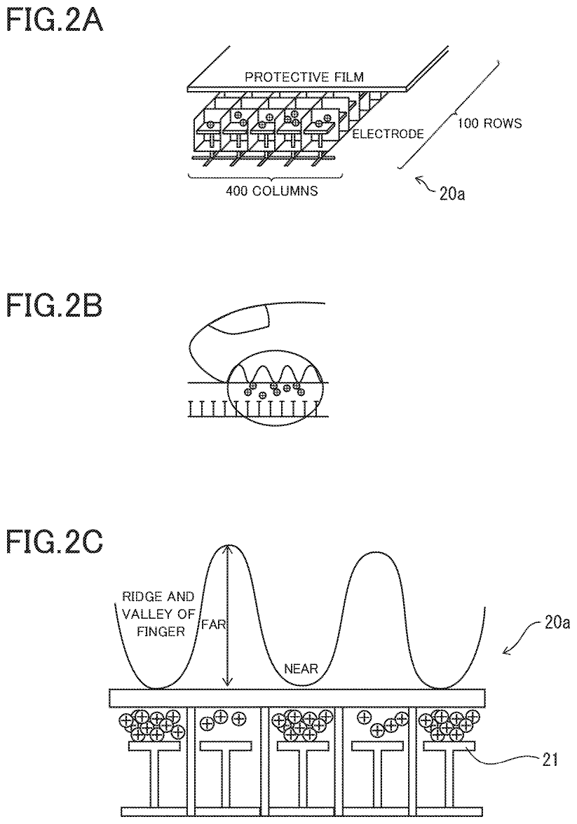

The specific configuration of the fingerprint sensor 20a is described with reference to FIG. 2A to FIG. 2C. The description below exemplifies the fingerprint sensor 20a, and another well-known technology may be used. FIG. 2A is a perspective view illustrating the configuration of the fingerprint sensor 20a of the smartphone 1A. FIG. 2B is a schematic sectional view illustrating the fingerprint sensor 20a being touched with a finger. FIG. 2C is a schematic sectional view illustrating the principal configuration of the fingerprint sensor 20a.

The fingerprint sensor 20a includes, below a protective film provided on the surface thereof, for example, 100 pixels in the vertical direction and 400 pixels in the horizontal direction, that is, forty thousand electrodes 21 in total. In the fingerprint sensor 20a, electric charges collect depending on an object that approaches the surface. This means that when the finger is brought into contact with the protective film, how the electric charges collect in the electrodes 21 with respect to the respective locations of the finger can be detected. Here, the percentage of the electric charges that collect in the electrode 21 varies depending on fingerprint ridges and valleys. Thus, the amount of electric charges is converted to generate an image. Specifically, the amount of electric charges is small when a distance between an electrode and the skin is large, while the amount of electric charges is large when the distance is small. With this, the fingerprint ridges and valleys can be read as images. The smartphone 1A registers the fingerprint of the user that the fingerprint sensor 20a has read to a memory. After the fingerprint has been registered, the smartphone 1A can determine whether or not the fingerprint of a finger that the user brings into contact with the fingerprint sensor 20a again is matched with the registered fingerprint.

In the related art, a frame region unrelated to display remains on each side of a fingerprint sensor. In the smartphone 1A of the present embodiment, however, on each side of the fingerprint sensor 20a, an extended display region EZ1, which is an extension of the touch panel display unit 11, is formed.

Thus, there can be provided the smartphone 1A that may make the frame region 12 as small as possible even in a case where the fingerprint sensor 20a is mounted on the same surface as the touch panel display unit 11. This means that, even the compact smartphone 1A can secure almost the entire screen as a space for the touch panel display unit 11. The configuration in which a large frame region is extended on each side of a fingerprint sensor as in the related art gives users an impression of the presence of wasted regions. Electronic devices such as smartphones are desirably compact in terms of portability and desirably include the largest possible screen in terms of the viewability of a screen and an increase in amount of information on a screen. Users do not appreciate the presence of such regions that seems wasted. Thus, the smartphone 1A that may make the frame region 12 as small as possible and may desirably achieve the smallest possible frame region 12 as in the present embodiment strongly attracts users.

Moreover, in the smartphone 1A of the present embodiment, the outer side on which the first notched portion 11a is formed is desirably the lower side of the touch panel display unit 11. In addition, in the smart-phone 1A of the present embodiment, the first notched portion 11a is desirably formed at the middle of the lower side being the lower outer side of the touch panel display unit 11, that is, the middle of the width direction of the touch panel display unit 11.

As a home button of the smartphone 1A, the fingerprint sensor 20a can be provided at a user-friendly position. In addition, the user further swipes after unlocking the screen with the fingerprint sensor 20a, thereby being capable of performing, for example, the basic operation of the smartphone 1A subsequently to the screen unlock operation.

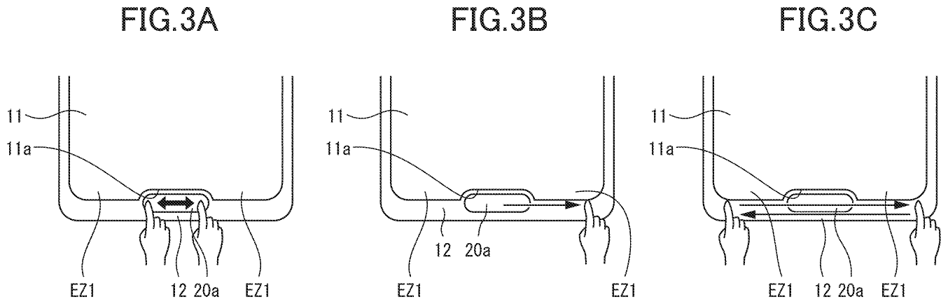

Here, the operation of the smartphone 1A including the fingerprint sensor 20a partly located inside the first notched portion 11a of the touch panel display unit 11 of the present embodiment is described with reference to FIG. 3A to FIG. 3C. In FIG. 3A to FIG. 3C, the illustration of a hand is a mark for indicating a pointed position. FIG. 3A is a principal-part plan view illustrating operation of unlocking through touching on the fingerprint sensor 20a of the smartphone 1A. FIG. 3B is a principal-part plan view illustrating operation of swiping right or left with the finger from the fingerprint sensor 20a to the extended display region EZ1, to thereby perform basic screen operation. FIG. 3C is a principal-part plan view illustrating operation of swiping with the finger from one of the extended display regions EZ1 to the other of the extended display regions EZ1 through the fingerprint sensor 20a, to thereby perform horizontal scroll operation on the screen.

First, when the user touches the fingerprint sensor 20awith the finger, the smartphone 1A returns from the standby mode. As illustrated in FIG. 3A, the user swipes right or left the fingerprint sensor 20a with the finger. Note that, whether to swipe right or swipe left is determined on the basis of user setting. With this, the fingerprint sensor 20a performs fingerprint authentication, and when the fingerprint is matched with the registered fingerprint, an overview screen appears on the touch panel display unit 11, for example. The “overview screen” means a recently used screen. Here, in the present embodiment, as illustrated in FIG. 3B, the user also swipes a region in addition to the fingerprint sensor 20a after passing through the fingerprint sensor 20a. With this, the user swipes with the finger in contact with the extended display region EZ1 at the lower end of the touch panel display unit 11, and in the present embodiment, the screen transitions from the overview screen to a history screen. For example, the thumbnails of recently used application screens are displayed in order in a scrolling manner.

Moreover, in the present embodiment, as illustrated in FIG. 3C, the user swipes with the finger the extended display regions EZ1 of the touch panel display unit 11, which are adjacent to the frame region 12 in the lower portion of the smartphone 1A, from left to right through the fingerprint sensor 20a, thereby being capable of scrolling the screen from the first page home screen to the final page home screen. On the other hand, the user swipes with the finger the extended display regions EZ1 of the touch panel display unit 11, which are adjacent to the frame region 12 in the lower portion of the smartphone 1A, from right to left through the fingerprint sensor 20a, thereby being capable of scrolling the screen from the final page home screen to the first page home screen.

These operations are enabled because the extended display regions EZ1 and EZ1 are present on the respective sides of the fingerprint sensor 20a, and the smartphone 1A includes, in each extended display region EZ1, a mechanism that recognizes these operations.

In the above description, which is exemplary, an example of cooperative operation for finger position detection of the fingerprint sensor 20a and the extended display region EZ1 on each side of the fingerprint sensor 20a is described. The present disclosure is not limited to these examples, and, with the extended display region EZ1 of the touch panel display unit 11 present on each side of the fingerprint sensor 20a, cooperative and continuous operation with the extended display regions EZ1 of the touch panel display unit 11 is enabled. Thus, as compared to a case where the fingerprint sensor 20a is provided on the surface opposite to the touch panel display unit 11, the user-friendliness is (quite enhanced.

### Embodiment 2

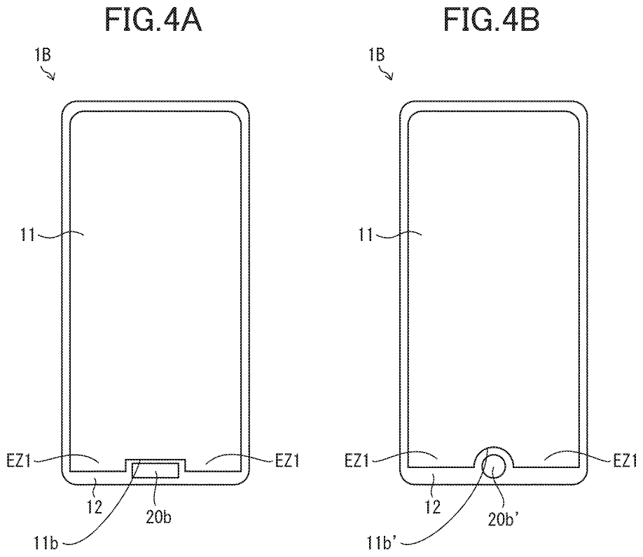

Another embodiment of the present disclosure is described with reference to FIG. 4A and FIG. 4B. Note that, configurations other than the ones described in the present embodiment are the same as those of Embodiment 1. Moreover, for illustrative purposes, members having the same functions as the members illustrated in the figures related to Embodiment 1 are denoted by the same reference characters, and description thereof is omitted.

A smartphone 1B that is an electronic device of the present embodiment is different from the configuration of the smartphone 1A of Embodiment 1 in shape of the touch panel display unit 11.

The smartphone 1B of the present embodiment has, as illustrated in FIG. 4A, a first notched portion 11b with a rectangular recessed portion formed at the middle of the lower side of the touch panel display unit 11 having a vertically long rectangular shape. Further, a fingerprint sensor 20b functioning as the touch sensor is provided so as to be at least partly located inside the first notched portion 11b.

With this, the first notched portion 11b can be formed as the rectangular recessed portion so as to be matched with the shape of the fingerprint sensor 20b having a rectangular shape, for example. As a result, a space between the fingerprint sensor 20b and the extended display region EZ1 is narrow, and a sense of discomfort due to difference in shapes between the fingerprint sensor 20b and the extended display region EZ1 can be reduced.

Further, the shape of the touch panel display unit 11 is the vertically long rectangular shape having rounded upper corners and lower corners without roundness, namely, acute corners, unlike the smartphone 1A of Embodiment 1. As a result, the upper portion of the touch panel display unit 11 is extended along the outline of the smartphone 1B having a vertically long rounded rectangular shape so that the frame region 12 can be narrow. Moreover, the lower portion of the touch panel display unit 11 is fit in the outline of the smartphone 1B having the vertically long rounded rectangular shape without chamfering the corner portions because the width of the frame region 12 is larger than those on other sides, like the smartphone 1A of Embodiment 1. Thus, the touch panel display unit 11 can be made larger.

In addition, as another example of the shape of the first notched portion, a first notched portion 11b′ can be formed as illustrated in FIG. 4B. The first notched portion 11b′ is formed as a semicircular recessed portion at the middle of the lower outer side of the touch panel display unit 11. Also with this configuration, the first notched portion 11b′ can be placed so as to be matched with the shape of a circular fingerprint sensor 20b′, for example. As a result, a space between the fingerprint sensor 20b′ and the extended display region EZ1 is narrow, and a sense of discomfort due to difference in shapes between the fingerprint sensor 20b′ and the extended display region EZ1 can be reduced. With the use of the fingerprint sensor 20b′ having such a shape, which is not an elongated shape, in fingerprint detection, fingerprint authentication can be performed only through touching on the fingerprint sensor 20b′ without swiping, which is preferable.

Also the smartphone 1B of the present embodiment provides effects similar to those of Embodiment 1.

### Embodiment 3

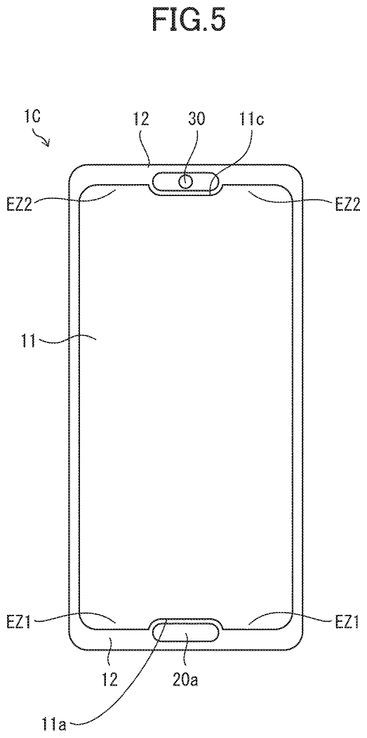

Another embodiment of the present disclosure is described with reference to FIG. 5. Note that, configurations other than the ones described in the present embodiment are the same as those of Embodiment 1.

A smartphone 1C that is an electronic device of the present embodiment is different from the configuration of the smartphone 1A of Embodiment 1 in that a second notched portion 11c is further formed on the outer side (upper side) opposite to the outer side on which the first notched portion 11a is formed of the touch panel display unit 11. More specifically, the second notched portion 11c provided at the middle of the upper side of the touch panel display unit 11.

Further, an image sensor 30 is provided so as to be at least partly located inside the second notched portion 11c.

The image sensor 30 is, for example, a camera. As a result, also in the frame region 12 on the side opposite to the outer side on which the first notched portion 11a is formed, an extended display region EZ2 of the touch panel display unit 11 can be provided on, for example, each side of the image sensor 30 such as a camera.

Thus, there can be provided the smartphone 1C that includes the image sensor 30 in the upper portion of the touch panel display unit 11, and may further reduce the frame region 12 and expand the touch panel display unit 11 to the extended display regions EZ2 and EZ2.

Moreover, the smartphone 1C of the present embodiment has the first notched portion 11a and the second notched portion 11c in part of both the upper and lower outer sides of the touch panel display unit 11 having the vertically long rectangular shape. With this, even in a case where it is difficult to accommodate sensors including the fingerprint sensor 20a only in the first notched portion 11a, the sensors can be provided.

Note that, modes that the second notched portion 11c may take are similar to those of the first notched portion 11a, and hence description thereof is omitted.

Moreover, in the present embodiment, there is described the mode in which the second notched portion 11c is formed in part of the side opposite to the outer side on which the first notched portion 11a is formed of the touch panel display unit 11 of the smartphone 1A of Embodiment 1. However, the configuration in which the second notched portion 11c is formed can be applied not only to the smartphone 1A of Embodiment 1, but also to the smartphone 1B of Embodiment 2.

### Embodiment 4

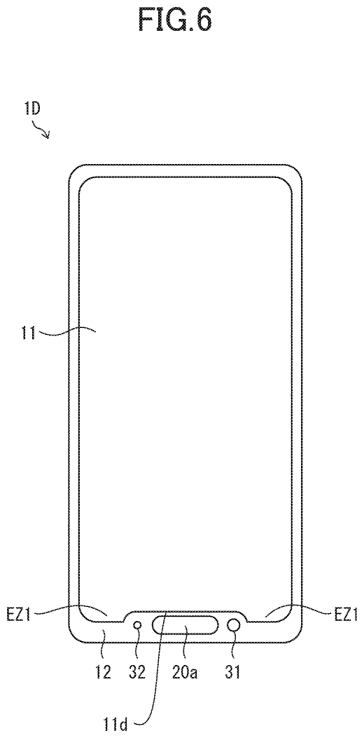

Another embodiment of the present disclosure is described with reference to FIG. 6. Note that, configurations other than the ones described in the present embodiment are the same as those of Embodiment 1.

In the smartphones 1A to 1C that are the electronic devices of Embodiments 1 to 3, one touch sensor is provided in the first notched portion 11a or 11b in the touch panel display unit 11. In contrast to this, a smartphone 1D that is an electronic device of the present embodiment is different from Embodiments 1 to 3 in that a plurality of sensors including the touch sensor are provided in a first notched portion 11d in the touch panel display unit 11.

FIG. 6 is a plan view illustrating the configuration of the smartphone 1D.

The smartphone 1D includes, as illustrated in FIG. 6, a plurality of sensors including the fingerprint sensor 20a functioning as the touch sensor in the first notched portion 11d in the touch panel display unit 11. The plurality of sensors include, for example, an image sensor 31 such as a camera and an illuminance meter 32 in addition to the fingerprint sensor 20a functioning as the touch sensor.

Also the smartphone 1D of the present embodiment provides effects similar to those of the embodiments described above.

Note that, in the description of the embodiments above, the electronic devices are the smartphones. An electronic device of one aspect of the present disclosure is, however, not necessarily limited to a smartphone. The electronic device can be, for example, a personal digital assistant such as a tablet terminal, or can be applied to other information devices such as stationary devices other than personal digital assistants.

Moreover, the lower side of the touch panel display unit 11 of the smartphones 1A to 1D of the respective embodiments is the short side of the touch panel display unit 11 having the vertically long rectangular shape. However, in a case where the electronic device is a tablet, for example, the electronic device is sometimes used with the long sides of the rectangle being horizontal. In such a case, the first notched portion may be provided in one of the short sides of the device such as a tablet. Alternatively, the first notched portion may be formed in the long sides of the electronic device. In addition, even in a case where the electronic device is a smartphone, for example, the first notched portion may be formed in part of the lower side that is not the middle of the lower side, or in part of the left side or the right side.

In each embodiment, the shapes of the first notched portion and the second notched portion are described with the specific examples. The shapes are, however, not necessarily limited to the shapes described above, and may be a polygonal shape such as a rectangular shape or part of a semicircle, a half ellipse, or a vertically long or horizontally long oval. Moreover, the shape of the notched portion is not limited to the one including straight lines, and can be any shape at least partly including curves. Note that, in a case where a sensor to be provided in the first notched portion is only the touch sensor, the first notched portion is desirably formed so as be matched with the shape of the touch sensor.

In each embodiment, the example in which the touch sensor is the fingerprint sensor is described. The touch sensor is, however, not necessarily limited to the fingerprint sensor, and may be another touch sensor or the like not having a function of detecting a fingerprint as an image. In this case, the electronic device does not support personal authentication with a fingerprint, but can be configured to return from the standby mode (power saving mode) to the normal operation mode by touching. In addition, the electronic device can be configured to have a function of a performing simple personal authentication on the basis of a combination of touching, swiping, or other operations.

Moreover, the smartphone 1A of the present embodiment has the first notched portion 11a that is a rectangular notch or a notch that is at least partly curved. With this, as the first notched portion, for example, a rectangular, half ellipsoid, semicircular, or track-shaped notch can be used. As a result, the first notched portion 11a can be formed so as to be matched with the shape of the touch sensor.

### [Conclusion]

According to Aspect 1 of the present disclosure, there is provided an electronic device including: a touch panel display unit that has a recessed first notched portion formed in part of an outer side of the touch panel display unit; and a touch sensor that is at least partly located inside the first notched portion.

According to the above-mentioned configuration, the electronic device that includes the touch sensor mounted on the same plane as the display unit and may make its frame region as small as possible can be achieved.

In the electronic device according to Aspect 2 of the present disclosure, the touch sensor may be a fingerprint sensor.

According to the above-mentioned configuration, personal authentication with a fingerprint is enabled, and a user can perform continuous operation by using the touch sensor and the touch panel display unit.

In the electronic device according to Aspect 3 of the present disclosure, a recessed second notched portion may be formed in part of a side opposite to the outer side on which the first notched portion is formed, and an image sensor that is at least partly located inside the second notched portion may be provided.

According to the above-mentioned configuration, the electronic device that further includes the image sensor and may make its frame region as small as possible can be achieved.

In the electronic device according to Aspect 4 of the present disclosure, the outer side on which the first notched portion is formed is desirably a lower side of the touch panel display unit.

According to the above-mentioned configuration, the electronic device that allows the user to easily perform operation on the touch sensor can be achieved.

In the electronic device according to Aspect 5 of the present disclosure, the first notched portion is desirably formed at a middle of the outer side.

According to the above-mentioned configuration, the user can perform various operations continuously between the extended display region of the touch panel display unit adjacent to the touch sensor and the touch sensor.

In the electronic device according to Aspect 6 of the present disclosure, the touch sensor may have a horizontally long shape parallel to the outer side on which the first notched portion is formed.

According to the above-mentioned configuration, the electronic device that may make its frame region as small as possible can be achieved.

In the electronic device according to Aspect 7 of the present disclosure, a plurality of sensors may be provided in the first notched portion, the plurality of sensors including the touch sensor.

According to the above-mentioned configuration, the plurality of sensors can be arranged in close proximity to each other.

In the electronic device according to Aspect 8 of the present disclosure, the outer side may be each side of a rectangular shape.

According to the above-mentioned configuration, in a case where the electronic device is a smartphone or a tablet, the touch panel display unit can be formed into a suitable shape.

Note that, one aspect of the present disclosure is not limited to each embodiment described above, and may be altered within the scope of the claims. An embodiment based on an appropriate combination of technical measures disclosed in different embodiments is also encompassed in the technical scope of one aspect of the present disclosure. In addition, a new technical feature can be achieved on the basis of a combination of technical measures disclosed in the embodiments.

The present disclosure contains subject matter related to that disclosed in Japanese Priority Patent Application JP 2018-187622 filed in the Japan Patent Office on Oct. 2, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic device comprising:
a touch panel display unit that has a recessed first notched portion formed in part of an outer side of the touch panel display unit; and
a touch sensor that is at least partly located inside the first notched portion.

2. The electronic device according to claim 1, wherein
the touch sensor is a fingerprint sensor.

3. The electronic device according to claim 1, wherein
a recessed second notched portion is formed in part of a side opposite to the outer side on which the first notched portion is formed, and
an image sensor that is at least partly located inside the second notched portion is provided.

4. The electronic device according to claim 1, wherein
the outer side on which the first notched portion is formed is a lower side of the touch panel display unit.

5. The electronic device according to claim 1, wherein
the first notched portion is formed at a middle of the outer side.

6. The electronic device according to claim 1, wherein
the touch sensor has a horizontally long shape parallel to the outer side on which the first notched portion is formed.

7. The electronic device according to claim 1, wherein
a plurality of sensors is provided in the first notched portion, the plurality of sensors including the touch sensor.

8. The electronic device according to claim 1, wherein
the outer side of the touch panel display unit is each side of a rectangular shape.
